(19) United States
(12) Patent Application Publication
(10) Pub. No.: US 2024/0276954 A1
(43) Pub. Date: Aug. 22, 2024

(54) Dog Walking Harness Assembly

(71) Applicant: Kevin Coombs, Kanata (CA)

(72) Inventor: Kevin Coombs, Kanata (CA)

(21) Appl. No.: 18/110,447

(22) Filed: Feb. 16, 2023

(51) Int. Cl. F16M 13/04; A01K 27/00

(52) U.S. Cl. CPC A01K 27/003; F16M 13/04

(57) ABSTRACT

A dog walking harness assembly for inhibiting a dog from running away from an owner includes a shoulder harness that has a chest belt and a pair of shoulder straps which can be worn on a user's upper torso. A strap is movably attached to the chest belt of the shoulder harness. The strap can be attached to a leash that is worn on a dog thereby facilitating the leash to be secured to the shoulder harness.

### REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dog walking devices and more particularly pertains to a new dog walking device for inhibiting a dog from running away from a user. The device includes a shoulder harness worn on a user and a strap attached to the shoulder harness. The device includes a coupler attached to the strap which can be attached to a leash worn on a dog. In this way the lease is secured to the shoulder harness thereby facilitating the user to maintain control of the dog.

### (2) Description of Related Art Including Information Disclosed Under 37 CFR 1.97 and 1.98

The prior art relates to dog walking devices including a dog walking harness that includes a waist belt, a strap releasably attachable to the weight belt and a leash attachable to the strap. The prior art discloses a shoulder harness that includes a waist belt and a pair of shoulder straps for securing a user to an object. The prior art discloses a dog walking harness that includes a waist belt and a leash that is releasably attachable to the waist belt. The prior art discloses a dog walking harness that includes a waist belt, a leash releasably attachable to the waist belt and a shock absorber integrated into the leash. The prior art discloses a dog walking harness which includes a vest, a leash releasably attachable to the vest and a shock absorber coupled between the vest and the leash.

### BRIEF SUMMARY OF THE INVENTION

An embodiment of the disclosure meets the needs presented above by generally comprising a shoulder harness that has a chest belt and a pair of shoulder straps which can be worn on a user's upper torso. A strap is movably attached to the chest belt of the shoulder harness. The strap can be attached to a leash that is worn on a dog thereby facilitating the leash to be secured to the shoulder harness.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a dog walking harness assembly according to an embodiment of the disclosure.

FIG. 2 is a back view of an embodiment of the disclosure.

FIG. 3 is a right side view of an embodiment of the disclosure.

FIG. 4 is a top view of an embodiment of the disclosure.

FIG. 5 is a bottom view of an embodiment of the disclosure.

FIG. 6 is a perspective in-use view of an embodiment of the disclosure.

### DETAILED DESCRIPTION OF THE INVENTION

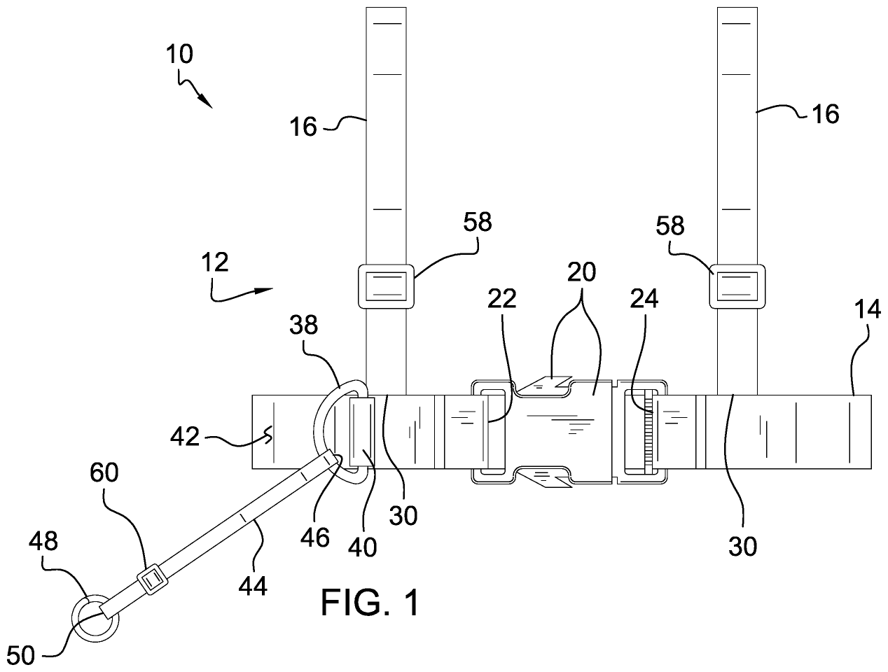

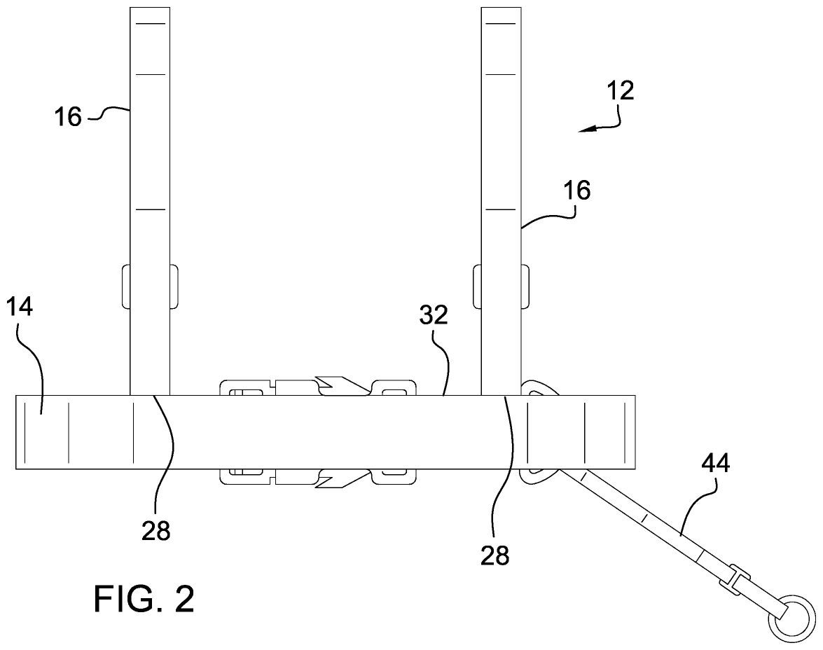

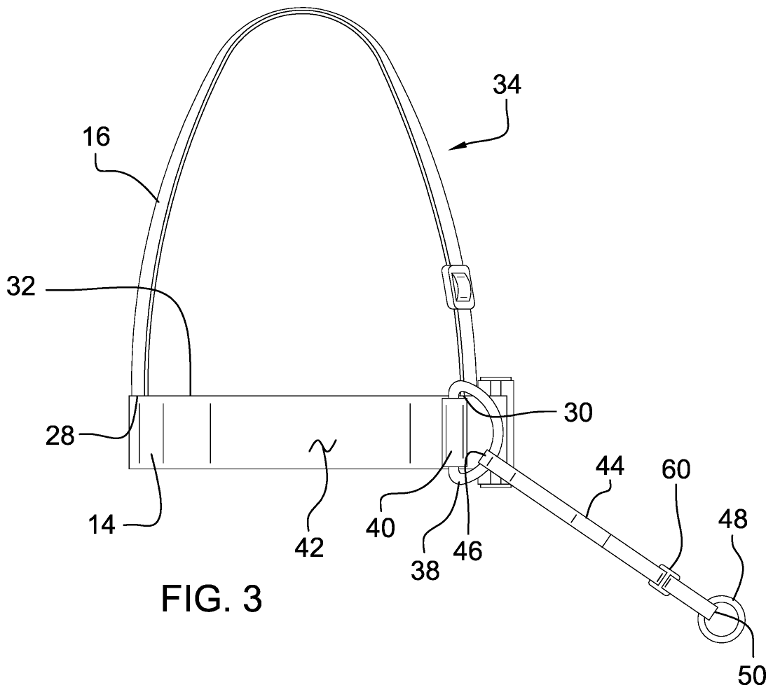

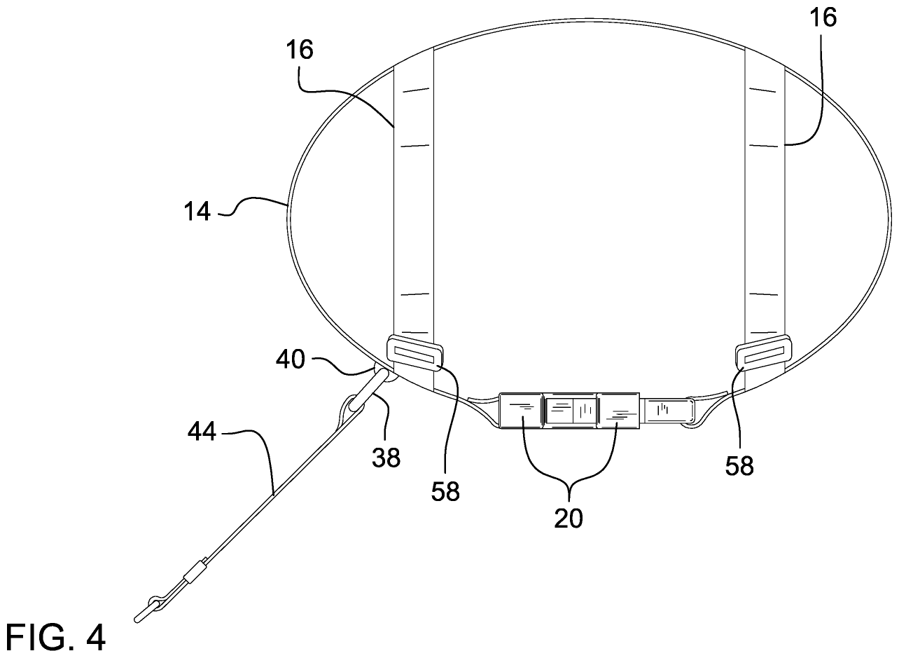

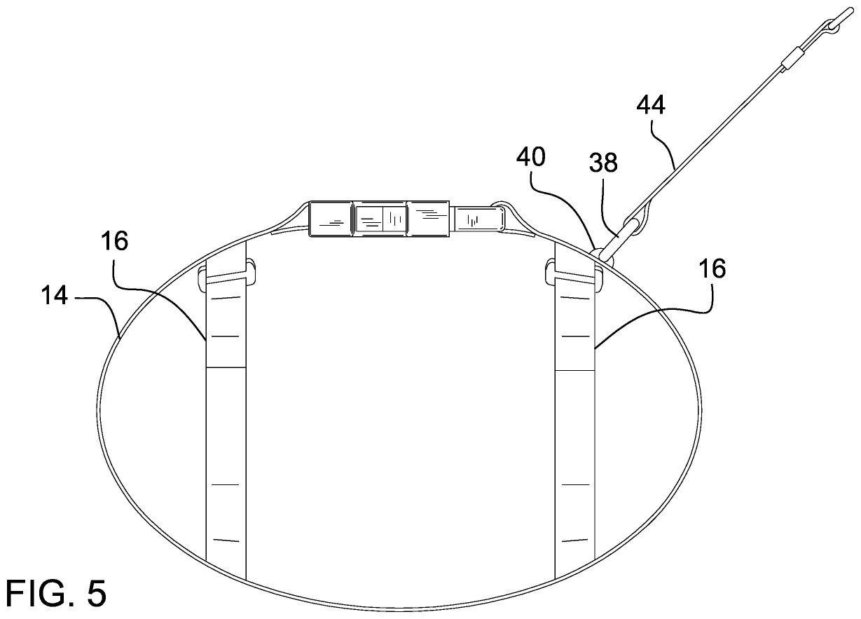

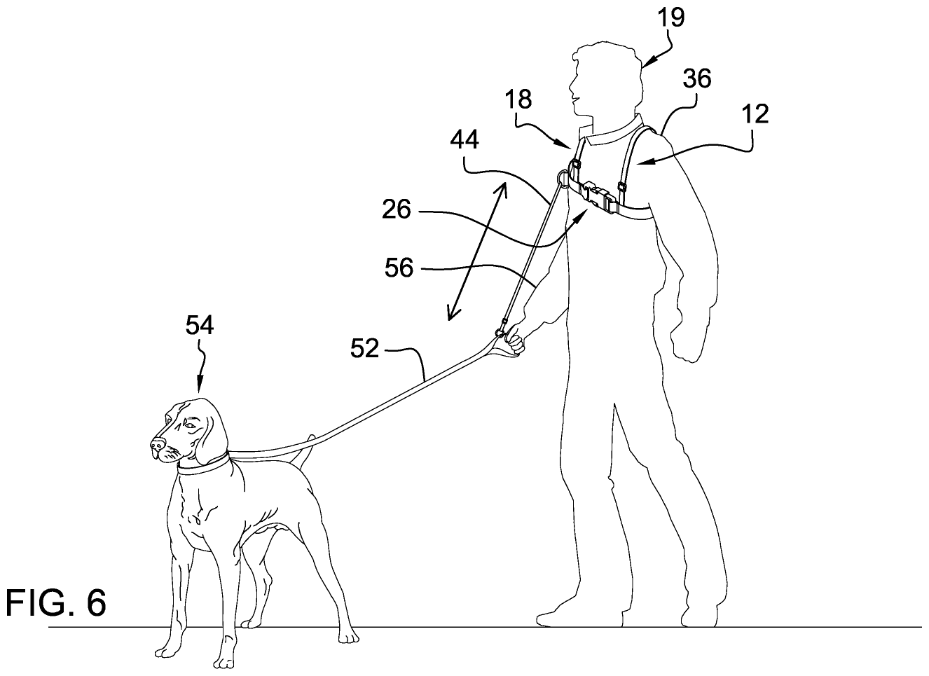

With reference now to the drawings, and in particular to FIGS. 1 through 6 thereof, a new dog walking device embodying the principles and concepts of an embodiment of the disclosure and generally designated by the reference numeral 10 will be described.

As best illustrated in FIGS. 1 through 6, the dog walking harness assembly 10 generally comprises a shoulder harness 12 that has a chest belt 14 and a pair of shoulder straps 16 that can be worn on an upper torso 18 of a user 19. The shoulder harness 12 includes a pair of chest couplers 20 each coupled to a respective one of a first end 22 and a second end 24 of the chest belt 14. Each of the pair of chest couplers 20 is releasably attachable to each other thereby forming the chest belt 14 into a closed loop for wearing the chest belt 14 around the user's chest 26. Each of the shoulder straps 16 has a primary end 28 and a secondary end 30 and each of the primary end 28 and the secondary end 30 of the pair of shoulder straps 16 is coupled to a top edge 32 of the chest belt 14. Thus, each of the pair of shoulder straps 16 forms an arch 34 to be worn over a respective one of the user's shoulders 36 when the chest belt 14 is worn around the user's chest 26.

A ring 38 is movably attached to an attachment point 40 which is disposed on an outwardly facing surface 42 of the chest belt 14. Additionally, the attachment point 40 is positioned closer to the first end 22 than the second end 24 of the chest belt 14. A leash strap 44 is movably attached to the chest belt 14 of the shoulder harness 12 and the leash strap 44 has a primary end 46 that is attached to the ring 38. A coupler 48 is provided and the coupler 48 is coupled to a secondary end 50 of the leash strap 44. The coupler 48 is urgeable into an open condition thereby facilitating the coupler 48 to be attached to a leash 52 worn on a dog 54. In this way the leash 52 can be secured to the shoulder harness 12. The leash strap 44 has a length that is less than a length of the user's arm 56 to inhibit the user's shoulder 36 from being injured when the dog 54 jerks on the leash 52. The coupler 48 may comprise a lobster claw, a snap ring or any other type of mechanical coupler that can releasably engage the leash 52.

A pair of shoulder adjusters 58 is provided and each of the shoulder adjusters 58 is disposed on a respective one of the shoulder straps 16 for adjusting a length of the respective shoulder strap 16. In this way the shoulder straps 16 can be adjusted to fit a variety of users 19. A strap adjuster 60 is provided and the strap adjuster 60 is disposed on the leash strap 44 for adjusting a length of the leash strap 44. In this way the leash strap 44 can be adjusted to accommodate various lengths of user's arms.

In use, the user 19 wears the shoulder harness 12 when the user 19 is walking their dog 54 and the leash 52 is attached to the coupler 48 on the leash strap 44. In this way the leash 52 will pull on the shoulder harness 12, rather than the user's shoulder 36, when the dog 54 unexpectedly bolts. Furthermore, the leash 52 cannot be pulled away from the user 19 when the user 19 looses their grip on the leash 52. In this way the shoulder harness 12 and the leash strap 44 enhance the ability of the user 19 to maintain control of the dog 54 while the user 19 is walking the dog 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog walking harness assembly for inhibiting a user's shoulder from being injured as a result of a dog jerking on a leash, said assembly comprising:
a shoulder harness having a chest belt and a pair of shoulder straps wherein said shoulder harness is configured to be worn on a user's upper torso; and
a strap being movably attached to said chest belt of said shoulder harness wherein said strap is configured to be attached to a leash being worn on a dog thereby facilitating the leash to be secured to said shoulder harness.

2. The assembly according to claim 1, wherein:
said shoulder harness includes a pair of chest couplers each being coupled to a respective one of a first end and a second end of said chest belt, each of said pair of chest couplers being releasably attachable to each other thereby forming said chest belt into a closed loop wherein said chest belt is configured to be worn around the user's chest;
each of said shoulder straps has a primary end and a secondary end, each of said primary end and said secondary end of said pair of shoulder straps being coupled to a top edge of said chest strap such that each of said pair of shoulder straps forms an arch wherein each of said shoulder straps is configured to be worn over a respective one of the user's shoulders when said chest belt is worn around the user's chest.

3. The assembly according to claim 2, further comprising a ring being movably attached to an attachment point being disposed on an outwardly facing surface of said chest belt, said attachment point being positioned closer to said first end than said second end of said chest belt.

4. The assembly according to claim 2, wherein:
said assembly includes a ring being attached to said chest leash strap;
said leash strap has a primary end being attached to said ring; and
said assembly includes a coupler being coupled to a secondary end of said leash strap, said coupler being urgeable into an open condition wherein said coupler is configured to be attached to a leash being worn on a dog thereby facilitating the leash to be secured to said shoulder harness, said leash strap having a length being less than a length of the user's arm wherein said leash strap is configured to inhibit the user's shoulder from being injured when the dog jerks on said leash.

5. A dog walking harness assembly for inhibiting a user's shoulder from being injured as a result of a dog jerking on a leash, said assembly comprising:
a shoulder harness having a chest belt and a pair of shoulder straps wherein said shoulder harness is configured to be worn on a user's upper torso, said shoulder harness including a pair of chest couplers each being coupled to a respective one of a first end and a second end of said chest belt, each of said pair of chest couplers being releasably attachable to each other thereby forming said chest belt into a closed loop wherein said chest belt is configured to be worn around the user's chest, each of said shoulder straps having a primary end and a secondary end, each of said primary end and said secondary end of said pair of shoulder straps being coupled to a top edge of said chest strap such that each of said pair of shoulder straps forms an arch wherein each of said shoulder straps is configured to be worn over a respective one of the user's shoulders when said chest belt is worn around the user's chest;
a ring being movably attached to an attachment point being disposed on an outwardly facing surface of said chest belt, said attachment point being positioned closer to said first end than said second end of said chest belt;
a leash strap being movably attached to said chest belt of said shoulder harness, said leash strap having a primary end being attached to said ring;
a coupler being coupled to a secondary end of said leash strap, said coupler being urgeable into an open condition wherein said coupler is configured to be attached to a leash being worn on a dog thereby facilitating the leash to be secured to said shoulder harness, said leash strap having a length being less than a length of the user's arm wherein said leash strap is configured to inhibit the user's shoulder from being injured when the dog jerks on said leash.

5. A dog walking harness system for inhibiting a user's shoulder from being injured as a result of a dog jerking on a leash, said system comprising:
a shoulder harness having a chest belt and a pair of shoulder straps wherein said shoulder harness is configured to be worn on a user's upper torso, said shoulder harness including a pair of chest couplers each being coupled to a respective one of a first end and a second end of said chest belt, each of said pair of chest couplers being releasably attachable to each other thereby forming said chest belt into a closed loop wherein said chest belt is configured to be worn around the user's chest, each of said shoulder straps having a primary end and a secondary end, each of said primary end and said secondary end of said pair of shoulder straps being coupled to a top edge of said chest strap such that each of said pair of shoulder straps forms an arch wherein each of said shoulder straps is configured to be worn over a respective one of the user's shoulders when said chest belt is worn around the user's chest;
a ring being movably attached to an attachment point being disposed on an outwardly facing surface of said chest belt, said attachment point being positioned closer to said first end than said second end of said chest belt;
a leash strap being movably attached to said chest belt of said shoulder harness, said leash strap having a primary end being attached to said ring;
a leash having a collar portion being configured to be worn around a neck of a dog, said leash having a handle portion being configured to be gripped by the user;
a coupler being coupled to a secondary end of said leash strap, said coupler being urgeable into an open condition thereby facilitating said coupler to be attached to said handle portion of said leash thereby facilitating the leash to be secured to said shoulder harness, said leash strap having a length being less than a length of the user's arm wherein said leash strap is configured to inhibit the user's shoulder from being injured when the dog jerks on said leash.
